(19) United States
(12) Patent Application Publication
(10) Pub. No.: US 2026/0139762 A1
(43) Pub. Date: May 21, 2026

(54) MULTIPORT ROTARY VALVE ASSEMBLY HAVING AT LEAST ONE ANCILLARY TANK OR CATCH POT

(71) Applicant: ILiAD IP COMPANY, LLC, Carlsbad, CA (US)

(72) Inventors: Aaron Philip POON, Tustin, CA (US); John Lucas DRONE, Aurora, IL (US); Saul Andres Lopez ORTIZ, Heber, CA (US); Julio Cesar BAEZA, Brawley, CA (US)

(73) Assignee: ILiAD IP COMPANY, LLC, Carlsbad, CA (US)

(21) Appl. No.: 19/395,723

(22) Filed: Nov. 20, 2025

Related U.S. Application Data
(60) Provisional application No. 63/723,219, filed on Nov. 21, 2024.
(60) Provisional application No. 63/723,975, filed on Nov. 22, 2024.

(51) Int. Cl. F16K 37/00; B01D 15/10; B01D 15/14; B01D 15/18; C01D 15/04; C22B 3/02; C22B 3/24; C22B 26/12; F16K 11/085

(52) U.S. Cl. CPC F16K 37/0091; B01D 15/102; B01D 15/14; B01D 15/1807; B01D 15/1871; C01D 15/04; C22B 3/02; C22B 3/24; C22B 26/12; F16K 11/0856

(57) ABSTRACT

A multiport rotary valve assembly is disclosed for fluid control in processes such as direct lithium extraction. The assembly includes a valve body with a housing ring, upper and lower closure discs, and a process disc featuring distribution channels in a sealed arrangement with leak detection channels. Ancillary tanks or catch pots are fluidly connected to leak detection ports to collect process fluid leakage, preventing crossover, contamination, and recovery loss. The assembly operates within a continuous countercurrent adsorption and desorption (CCAD) circuit, which includes multiple process zones with adsorbent beds or columns for selective lithium recovery. The collected fluid can be analyzed and redirected to appropriate process zone(s) or other inlet, outlet, point, or location in the flow path of the CCAD circuit, enhancing recovery and product purity. Sensors, pressure regulation devices, and other instrumentation monitor and control fluid dynamics.

### CROSS-REFERENCE TO RELATED APPLICATIONS

This application claims the benefit of United States Provisional Ser. No. 63/723,219 filed Nov. 21, 2024, and incorporates the provisional application by reference in its entirety into this document as if fully set out at this point.

### BACKGROUND OF THE INVENTION

### 1. Field of the Invention

The present disclosure relates to fluid control systems, specifically to multiport rotary valve assemblies with ancillary tanks or catch pots for preventing crossover, enhancing recovery, and improving product purity in direct lithium extraction processes.

### 2. Description of the Related Art

The use of multiport rotary valve assemblies in fluid control systems has become increasingly prevalent in processes that require precise management of multiple fluid streams. These assemblies typically employ a rotatable disc within a housing ring, sealed by closure discs and gasket or O-ring arrangements, to direct fluids through designated distribution channels. Such systems are particularly useful in scenarios where sequential or countercurrent fluid flows need to be reliably isolated and routed, especially in mineral recovery operations that require rigorous separation and minimal cross-contamination. As the demand for specialized valve technologies grows, there is also a growing need to address the mechanical and thermal stresses imposed on these components during extended service.

Continuous countercurrent adsorption and desorption circuits can be utilized in selective extraction processes, particularly for materials such as lithium. In these circuits, multiport rotary valves function to alternately direct feed solutions, rinse streams, and eluents through resin or adsorbent beds arranged in multiple process zones. Achieving high throughput and consistent performance in such circuits is necessary to maintain product quality, operational efficiency, and economic viability. Effective fluid distribution and leak management within the valve assembly directly affect the overall success of extraction operations, influencing both recovery rates and downstream processing requirements.

Despite their utility, existing multiport valve solutions encounter challenges related to thermal fluctuations, pressure differentials, and mechanical tolerances. Variations between ambient temperatures and elevated process temperatures can induce dimensional distortions in valve discs and housings, undermining seal integrity. High differential pressures across seal interfaces necessitate elevated compression forces from fasteners or tensioning rods, which in turn increase wear on sealing surfaces and amplify motor and gearbox loads. Manual tightening to compensate for progressive leakage can introduce inconsistencies, making it more challenging to achieve reliable and repeatable sealing performance under dynamic operating conditions.

High-pressure flow regimes and temperature-induced seal relaxation also lead to fluid crossover through intermediate inspection or drain ports, resulting in unintended mixing of process streams. In applications requiring exceptionally high purity—such as direct lithium extraction, where impurity rejection often exceeds 99.9%—even minor crossflow can degrade product quality and reduce overall recovery. Current arrangements that merely provide leak-detection ports fall short of preventing contamination or capturing displaced fluid for reintegration, creating a clear need for a valve-level solution that both isolates and collects leakage streams for controlled return to the process circuit.

### SUMMARY OF THE INVENTION

Therefore, it is desirable to provide a multiport rotary valve assembly with at least one ancillary tank or catch pot to prevent crossovers, enhance recovery, and improve product purity during direct lithium extraction. The crossover ports of the valve assembly are fluidly connected to the ancillary tanks or catch pots, and the collected crossover fluid can then be pumped back to the appropriate process zone or other inlet, outlet, point, or location in the flow path, mitigating crossover and preventing contamination or lithium recovery loss.

The arrangement of the valve body components, including the housing ring, upper closure disc, lower closure disc, and process disc, ensures a sealed configuration that effectively isolates process fluid distribution channels from leak detection channels. This physical arrangement minimizes fluid crossover and contamination between different fluid streams within the valve assembly, which is necessary in applications requiring high purity, such as direct lithium extraction.

The integration of leak detection ports in fluid communication with the leak detection channels allows for the identification and redirection of any process fluid leakage. By connecting these leak detection ports to an ancillary tank or catch pot, the assembly captures and collects leaked fluids, preventing them from mixing with other process streams. The assembly not only mitigates contamination risks but also enables the recovery and reintegration of process fluids into the process flow, enhancing overall efficiency and reducing material losses.

The ancillary tank or catch pot may be implemented as a consolidated unit or as a plurality of individual tanks, may operate at low fluid pressure while the valve assembly operates at high fluid pressure, and may incorporate sensors or instrumentation. A pressure reduction regulator or back-pressure regulator may be provided to monitor and control the differential pressure between the catch pot and the valve assembly. The differential pressure facilitates the directed flow of leaked fluids from the leak detection channels to the catch pot, ensuring efficient collection without requiring additional mechanical intervention. This configuration reduces the likelihood of fluid crossover and maintains the integrity of the process streams.

The sealed arrangement of the process disc with the leak detection channels, combined with the ancillary tank or catch pot, provides a robust solution to address the challenges of fluid leakage and crossover in multiport rotary valve assemblies. This design improves operational reliability, ensures consistent product purity, and supports the economic viability of processes such as continuous countercurrent adsorption and desorption circuits.

In general, in a first aspect, the invention relates to a multiport rotary valve assembly comprising a valve body that includes a housing ring with an upper closure disc and a lower closure disc attached at opposing ends, and a process disc seated within the housing ring. The process disc defines distribution channels in a sealed arrangement with leak detection channels, and the housing ring and closure discs include leak detection ports in fluid communication with those channels. An ancillary tank or catch pot is fluidly connected to the leak detection ports and is configured to collect any process fluid leakage from the distribution channels into the leak detection channels.

In an embodiment, the ancillary tank or catch pot is a consolidated catch pot fluidly connected to the leak detection ports in the housing ring.

In an embodiment, the ancillary tank or catch pot is a plurality of ancillary tanks or catch pots, and each catch pot is fluidly connected to one or more leak detection ports in the housing ring and/or closure discs.

In an embodiment, a level sensor, a volume sensor, a pressure regulation sensor, and/or other sensor or instrumentation is fluidly coupled to the ancillary tank or catch pot.

In an embodiment, the catch pot is configured to operate at low fluid pressure, and the valve assembly is configured to operate at high fluid pressure.

In an embodiment, a pressure regulation sensor or instrumentation, such as a pressure reduction regulator or a back-pressure regulator, is fluidly connected to the catch pot and the valve assembly to monitor and/or control the differential pressure between the catch pot and the valve assembly.

In an embodiment, a conductivity sensor, a nuclear magnetic resonance analyzer, an ion-selective electrode sensor, a total dissolved solids analyzer, a density sensor, a flow sensor, an electrochemical sensor, a photochemical sensor, a spectrometry sensor, or other lithium detection sensor or instrumention, or a combination thereof is fluidly connected to the catch pot and configured to monitor and/or analyze the type of process fluid leakage collected and ensure that the collected process fluid leakage is recycled to the appropriate process zone or fluid stream (via ancillary tankage, pumps, or other equipment).

The multiport rotary valve assembly, integrated within a continuous countercurrent adsorption and desorption (CCAD) circuit, enables precise fluid management across multiple process zones, each containing adsorbent or resin beds. By incorporating an ancillary tank or catch pot in fluid communication with the valve body, the assembly effectively captures and isolates process fluid leakage. This arrangement prevents unintended fluid crossover between zones, which is necessary for preserving the integrity of the adsorption and desorption processes.

The ancillary tank or catch pot ensures that leaked fluids are collected and redirected to appropriate process zone(s), unit(s), and/or process stream(s), thereby mitigating contamination risks and preserving the purity of the product. This design also minimizes material losses by reintegrating the collected leakage into the process flow, enhancing overall recovery efficiency. The physical separation of the ancillary tank or catch pot from the high-pressure zones of the valve assembly further facilitates controlled fluid dynamics, reducing the likelihood of operational disruptions caused by pressure imbalances.

In practical applications, such as direct lithium extraction, this configuration supports the production of high-purity lithium by maintaining the separation of process streams. The ability to manage fluid leakage in real-time ensures consistent performance of the CCAD circuit, improving operational reliability and economic viability.

In general, in a second aspect, the invention relates to a continuous countercurrent adsorption and desorption circuit having a multiport rotary valve assembly with a plurality of process zones, each zone containing one or more adsorbent or resin beds or columns. At least one ancillary tank or catch pot is placed in fluid communication with one or more of the process zones to collect process fluid leakage from the valve assembly. The catch pots may be arranged as multiple tanks or as a single, consolidated tank and can be dedicated to specific zones, such as brine displacement, brine loading, strip displacement, and product strip. The circuit may further include sensors or instrumentation coupled to the catch pot and the valve assembly, as well as a controller for regulating fluid flow and managing leakage.

In an embodiment, the ancillary tank or catch pot is a consolidated catch pot in fluid communication with one or more of the process zones.

In an embodiment, the consolidated catch pot is in fluid communication with a brine displacement zone, a brine loading zone, a strip displacement zone, and a product strip zone.

In an embodiment, the ancillary tank or catch pot is a plurality of ancillary tanks or catch pots, and each catch pot is in fluid communication with one or more of the process zones.

In an embodiment, a feed displacement catch pot is in fluid communication with the brine displacement zone, a product loading catch pot is in fluid communication with the brine loading zone, a strip displacement catch pot is in fluid communication with the strip displacement zone, and a product strip catch pot is in fluid communication with the product strip zone.

In an embodiment, the feed displacement catch pot is positioned upstream with respect to the fluid flow of and in fluid communication with the product loading catch pot, the product loading catch pot is positioned upstream with respect to the fluid flow of and in fluid communication with the strip displacement catch pot, the strip displacement catch pot is positioned upstream with respect to fluid flow of and in fluid communication with the product strip catch pot, and the product strip zone is positioned upstream with respect to the fluid flow of and in fluid communication with the feed displacement catch pot.

In an embodiment, each of the process zones is in fluid communication with a leak detection channel of the multiport rotary valve assembly, each of the leak detection channels is in fluid communication with a leak detection port of the multiport rotary valve assembly, and each of the leak detection ports is fluidly connected to one or more of the ancillary tank or catch pot.

In an embodiment, the multiport rotary valve assembly further includes a process disc having process fluid distribution channels in a sealed arrangement with the leak detection channels, and the catch pot is configured to collect process fluid leakage from the distribution channels to the leak detection channels.

In an embodiment, a level sensor, a volume sensor, a pressure regulation sensor, and/or other sensor or instrumentation is fluidly coupled to the ancillary tank or catch pot.

In an embodiment, the catch pot is configured to operate at low fluid pressure, and the valve assembly is configured to operate at high fluid pressure.

In an embodiment, a pressure regulation sensor or instrumentation, such as a pressure reduction regulator or a back-pressure regulator, is fluidly connected to the catch pot and the process disc to monitor and/or control the differential pressure between the catch pot and the valve assembly.

In an embodiment, conductivity sensor, a nuclear magnetic resonance analyzer, an ion-selective electrode sensor, a total dissolved solids analyzer, a density sensor, a flow sensor, an electrochemical sensor, a photochemical sensor, a spectrometry sensor, and/or other lithium detection sensor or instrumention is fluidly connected to the catch pot and configured to monitor and/or analyze the type of process fluid leakage collected and ensure that the collected process fluid leakage is recycled to the appropriate process zone and/or fluid stream.

The disclosed invention further provides a systematic approach to managing fluid leakage in a continuous countercurrent ion exchange or adsorption and desorption (CCAD) circuit, particularly in applications such as direct lithium extraction. By incorporating an ancillary tank or catch pot in fluid communication with the multiport rotary valve assembly, the process ensures that any process fluid leakage is effectively collected and redirected to appropriate locations within the circuit. This arrangement mitigates the risk of fluid crossover between process zones, which is significant for maintaining the separation of distinct fluid streams and preventing contamination.

The integration of an ancillary tank or catch pot enables the recovery and reintegration of leaked fluids into the process flow, thereby reducing material losses and enhancing overall recovery efficiency. This is particularly advantageous in high-purity applications, such as lithium extraction, where even minor contamination can significantly degrade product quality. The ability to pump the collected fluid leakage to specific tanks, process units, or process zones ensures that the recovered fluid is utilized in a controlled and efficient manner, further improving the economic viability of the process.

Additionally, the process supports the production of high-purity lithium by maintaining strict separation of process streams and preventing unintended mixing. This is achieved through the sealed arrangement of the valve assembly and the controlled operation of the ancillary tank or catch pot. The practical implementation of this process addresses the limitations of conventional systems, which often fail to prevent cross-contamination or recover displaced fluids effectively, thereby improving operational reliability and product purity.

In general, in a third aspect, the invention relates to a process comprising concentrating a brine or feedstock solution using the continuous countercurrent adsorption and desorption circuit to form an enhanced product solution; collecting process fluid leakage from the process zones via one or more ancillary tanks or catch pots; and pumping the collected leakage to a tank, process unit, process zone, or other point in the flow path of the circuit. This approach mitigates crossover leakage, prevents contamination or product recovery loss, and increases product purity. The process may involve pumping leakage upstream or downstream or inline to a predetermined channel or zone (for example, a feed tank), incorporating collected leakage with the brine or feedstock, strip, or product solutions to form a combined fluid solution, monitoring and controlling parameters such as level, volume, pressure, flow rate, flow path, and temperature via a controller, regulating differential pressure between the catch pot and valve assembly, determining the type of leakage collected, and routing leakage to the appropriate process zone. This process is applicable, for example, to direct lithium extraction.

In an embodiment, the step of pumping further includes pumping the collected fluid leakage upstream or downstream to the tank (e.g., a feed tank), process unit, process zone, or other inlet, outlet, point, or location in the flow path of the continuous countercurrent adsorption and desorption circuit.

In an embodiment, the collected fluid leakage is incorporated with the brine or feedstock solution to form a combined brine or feedstock solution.

In an embodiment, the collected fluid leakage is incorporated with the product solution to recover lithium if the collected leakage is determined to be free of impurities.

In an embodiment, the collected fluid leakage is incorporated with the strip solutions if the collected leakage chemistry is determined to be a strip solution.

In an embodiment, the step of pumping further includes pumping the collected fluid leakage inline to the multiport rotary valve assembly to a predetermined channel or process zone.

In an embodiment, the process also includes incorporating the collected fluid leakage with the brine or feedstock solution, a strip solution, and/or a product solution to form a combined fluid solution; and pumping the combined fluid solution to the tank, process unit, process zone, or other inlet, outlet, point, or location in the flow path of the continuous countercurrent adsorption and desorption circuit.

In an embodiment, the process also includes monitoring and/or controlling a level, volume, pressure, flow rate, flow path, temperature, or other process parameter of the ancillary tank or catch pot, the continuous countercurrent adsorption and desorption circuit, or both using a controller.

In an embodiment, the process also includes regulating differential pressure between the ancillary tank or catch pot and the multiport rotary valve assembly.

In an embodiment, the process also includes collecting the process fluid leakage from a leak detection port of the multiport rotary valve assembly, and the leak detection port is in fluid communication with a leak detection channel and a distribution channel of the multiport rotary valve assembly.

In an embodiment, the process also includes collecting the process fluid leakage from a brine displacement zone, a brine loading zone, a strip displacement zone, and a product strip zone using a consolidated ancillary tank or catch pot.

In an embodiment, the process also includes collecting the process fluid leakage from a brine displacement zone using a brine displacement catch pot, from a brine loading zone using a brine loading catch pot, from a strip displacement zone using a strip displacement catch pot, and from a product strip zone using a product strip catch pot.

### BRIEF DESCRIPTION OF DRAWINGS

The above and other objects and advantages of this invention may be more clearly seen when viewed in conjunction with the accompanying drawing wherein:

FIG. 1 is a process flow diagram of an example of a multiport rotary valve assembly having catch pots constructed in accordance with an exemplary embodiment.

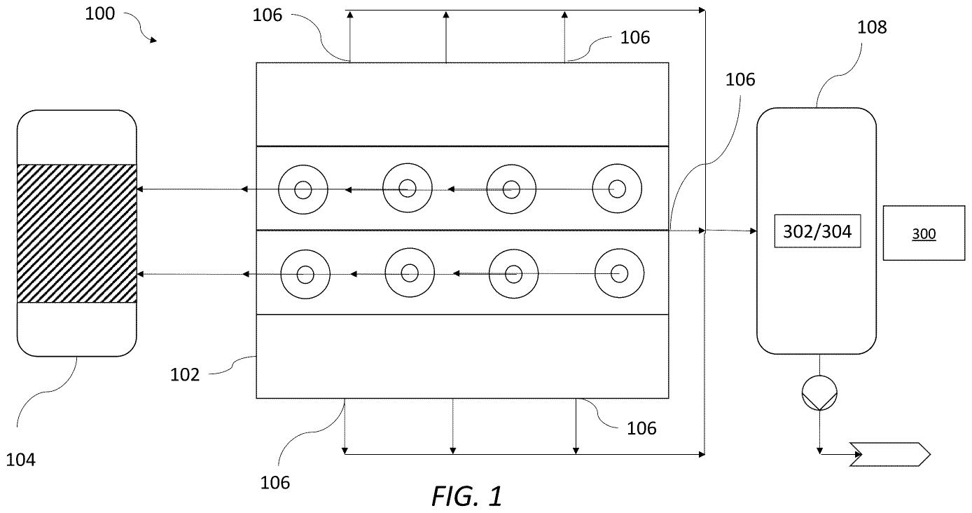

FIG. 2 is an elevation view of an example of a multiport rotary valve assembly.

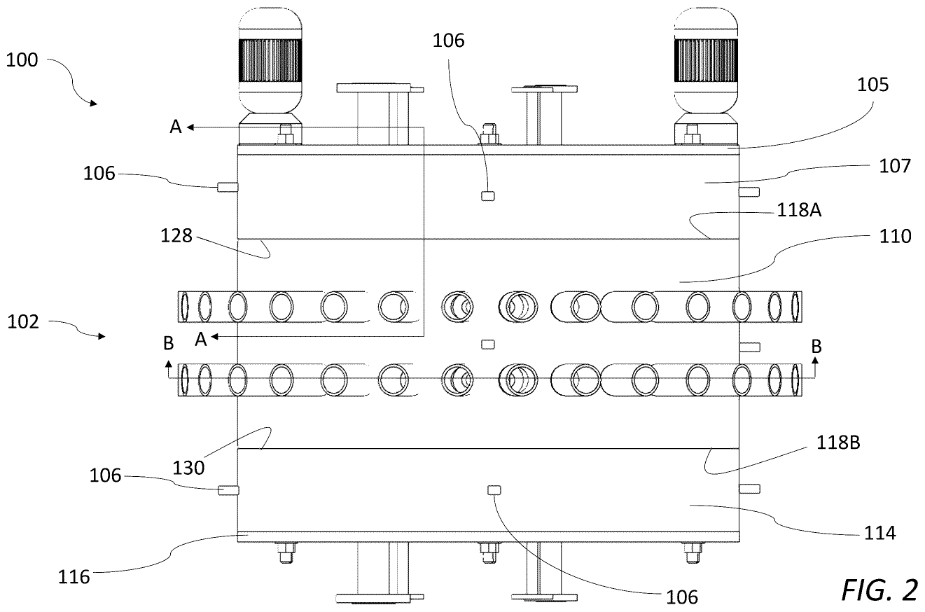

FIG. 3 is a perspective view of the valve assembly shown in FIG. 2.

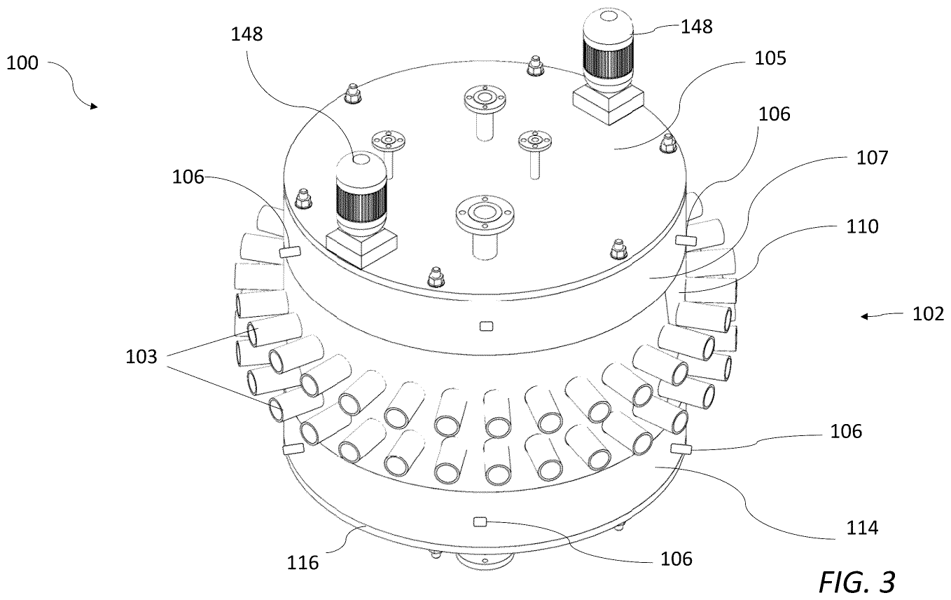

FIG. 4 is a cross-sectional view along lines A-A of FIG. 2.

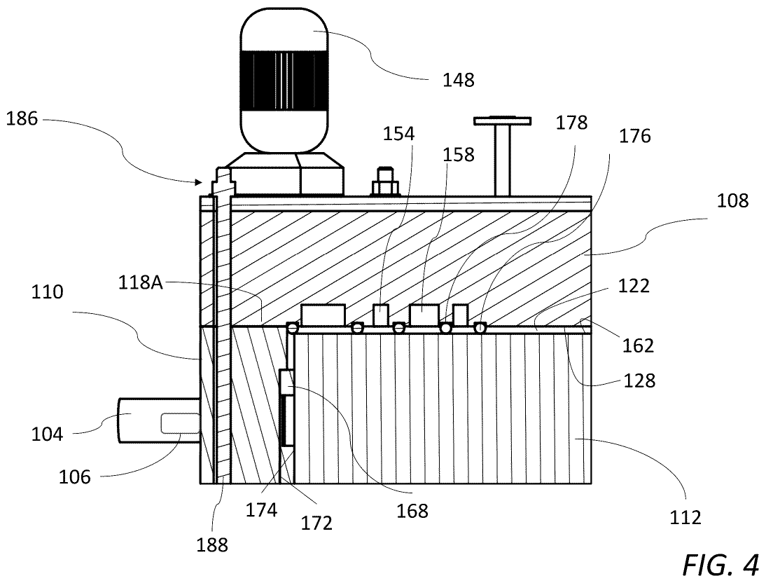

FIG. 5 is a cross-sectional view along lines B-B of FIG. 2.

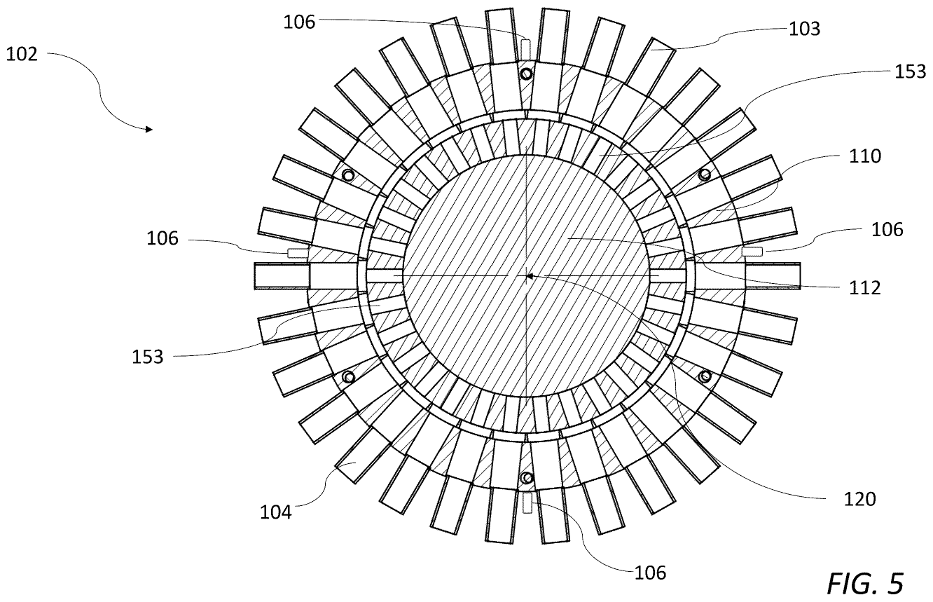

FIG. 6 is a process flow diagram of an example of a continuous countercurrent adsorption and desorption process and circuit having a consolidated auxiliary tank or catch pot in accordance with an exemplary embodiment.

FIG. 7 is a process flow diagram of another example of a continuous countercurrent adsorption and desorption process and circuit having a plurality of auxiliary tanks or catch pots in accordance with an exemplary embodiment.

FIG. 8 is a process flow diagram of another example of a continuous countercurrent adsorption and desorption process and circuit having a consolidated auxiliary tank or catch pot in accordance with an exemplary embodiment.

FIG. 9 is a process flow diagram of another example of a continuous countercurrent adsorption and desorption process and circuit having a plurality of auxiliary tanks or catch pots in accordance with an exemplary embodiment.

### DETAILED DESCRIPTION

The following detailed description provides illustrative embodiments of the disclosed subject matter and is not intended to limit the scope of the claims. The disclosed subject matter generally relates to fluid control systems, particularly multiport rotary valve assemblies with ancillary tanks or catch pots, which are designed to enhance fluid management, prevent crossover, and improve recovery and product purity in processes such as direct lithium extraction. The disclosed embodiments are presented in the context of continuous countercurrent ion exchange and adsorption and desorption (CCAD) circuits, but the principles and features described herein may be applicable to other fluid control and separation systems.

The examples and embodiments described are provided for illustrative purposes only and are not intended to cover all possible scenarios. Certain well-known components, configurations, and techniques may not be described in detail to avoid obscuring the subject matter, as they are readily understood by those skilled in the art. Modifications, substitutions, and rearrangements of the described elements and processes are possible without departing from the scope of the subject matter, as defined by the appended claims. The described subject matter is intended to include all such variations and equivalents.

The field of fluid control systems, particularly in applications such as direct lithium extraction (DLE), often relies on multiport rotary valve assemblies to manage the precise routing of multiple fluid streams. These assemblies play a role CCAD circuits, enabling the sequential flow of feed solutions, rinse streams, and eluents through adsorbent or resin beds across multiple process zones. However, conventional multiport rotary valve designs face significant challenges that hinder their performance and reliability. Specifically, issues such as thermal fluctuations, pressure differentials, and mechanical tolerances can compromise seal integrity, leading to fluid leakage and crossover between process streams. This unintended mixing of fluids not only degrades product purity but also reduces recovery efficiency, particularly in high-purity applications like lithium extraction, where impurity rejection rates often exceed 99.9%. Existing solutions, which typically rely on leak-detection ports, fail to adequately prevent contamination or recover displaced fluids, resulting in operational inefficiencies and economic losses.

The present disclosure addresses these limitations by introducing a multiport rotary valve assembly equipped with at least one ancillary tank or catch pot that is fluidly connected to leak detection ports within the valve body. This design prevents fluid crossover by capturing leakage at intermediate ports between seals and redirecting the leakage to appropriate process zones, tanks, or units within the CCAD circuit. By integrating ancillary tanks or catch pots, the system not only isolates leakage but also enables controlled reintegration of the leakage into the process flow, thereby mitigating contamination risks and enhancing lithium recovery. Additionally, the invention incorporates sensors and instrumentation, such as pressure regulation devices, level sensors, and conductivity analyzers, to monitor and control fluid dynamics in real time. These features support operation by maintaining differential pressures between the valve assembly and the catch pots, while also enabling the characterization and recycling of collected fluids based on their composition. This approach improves upon prior designs by enhancing operational efficiency, maintaining product purity, and reducing material losses, thereby providing a robust and scalable solution for high-demand fluid control applications.

This invention generally relates to a continuous countercurrent adsorption and desorption (or ion exchange) process and circuit for the selective recovery of lithium and minerals from natural and synthetic brines or feedstock solutions. The CCAD circuit features a multiport rotary valve assembly with multiple process zones, each containing an adsorbent or resin bed or column. At least one ancillary tank or catch pot is in fluid communication with the multiport valve assembly to prevent crossover and enhance recovery during direct lithium extraction. Crossover ports of the valve assembly are fluidly connected to the ancillary tanks or catch pots, and the collected crossover fluid can be pumped to a selected tank, process unit, process zone, or other inlet, outlet, point, or location in the flow path of the CCAD circuit, mitigating crossover, preventing contamination or lithium recovery loss, and increasing lithium purity.

The brine or feedstock solution can be from any lithium brine deposit or resource, such as continental brines, salar brines, geothermal brines, oil field feedstock solutions, brine evaporation ponds, leachate solutions from ore, hard rock, clay, or spodumene lithium mining and beneficiation, solutions from battery recycling processes, mother liquors, pregnant leach or liquor solutions (PLS), or any other lithium-containing brine or solution. The feedstock solution may be subject to a variety of preliminary treatment steps, including the removal of solids and certain problem metals or metals of commerce (e.g., iron, manganese, zinc, silicon, etc.), and brine from hard rock lithium mining activity, clay, spodumene, battery metal recycling, and other PLS feedstock solutions are generally leached with sulfuric acid (H₂SO₄).

As illustrated in the figures, a multiport rotary valve assembly 100 comprises a valve body 102 that is fluidly connected to a plurality of external ion exchange or adsorption and desorption columns or beds 104, facilitating process fluid distribution and transport during the CCAD process. The beds or columns 104 are arranged into process zones, each containing the adsorbent or resin (e.g., a lithium-or mineral-selective adsorbent or ion exchange resin). The valve body 102 of the multiport rotary valve assembly 100 includes an upper deflection plate 105, an upper closure disc 107, a body or housing ring 110, a process disc 112, a lower closure disc 114, and a lower deflection plate 116. The housing ring 110 has opposing generally planar axial or open ends 118A/118B and is configured to surround the perimeter of the process disc 112. The housing ring 110, along with the upper and lower closure discs 107 and 114, defines an internal valve chamber 122. The process disc 112 is seated within the internal valve chamber 122 and is rotatable about a central axis 120. The upper closure disc 107, the process disc 112, and the lower closure disc 114 are coaxially aligned and axially spaced along the central axis 120.

The housing ring 110 defines end openings 118A/118B with the upper closure disc 107 and the lower closure disc 114 secured thereto, respectively. The upper deflection plate 105, the upper closure disc 107, the lower closure disc 114, the lower deflection plate 116, and/or the housing ring 110 can be flanged, threaded, or otherwise configured to match that of the mating connection. The process disc 112 is seated within the internal valve chamber 122 of the housing ring 110 and rotates at a predetermined rate about the central axis 120 to direct the process fluid flow to and from the columns or vessels in predetermined process sequences. The process disc 112 rotation is driven by one of several possible external motors, gearboxes, and internal gearing arrangements (e.g., gearmotor 148, which can be affixed to the upper deflection plate 105).

The brine or feedstock solution is fluidly sent to influent passageways 154 in the upper closure disc 107 and influent passageways (not shown/mirror image of the influent passageways 154 in the upper closure disc 107) in the lower closure disc 114, respectively extending through the upper closure disc 107 and the lower closure disc 114. A product stream is fluidly sent to effluent passageways 158 in the upper closure disc 107 and effluent passageways (not shown/mirror image of the effluent passageways 158 in the upper closure disc 107) in the lower closure disc 114, which respectively extend through the upper closure disc 107 and the lower closure disc 114. The influent passageways 154 and the effluent passageways 158 in the upper closure disc 107 and the influent passageways and the effluent passageways in the lower closure disc 114 are fluidly connected to one or more distribution channels 153 on or in the process disc 112. The distribution channels 153 are open to an upper sealing surface 162 and a lower sealing surface (not shown) of the process disc 112 such that each distribution channel 153 corresponds to one of the influent passageways 154 and one of the effluent passageways 158, which correspond to a particular process zone and is sealed against the other zones using concentric internal seals or seal assemblies 176 in the upper sealing surface 162 or the lower sealing surface 164. The distribution channels 153, the influent passageways 154, and the effluent passageways 158 are respectively aligned during the rotation of the process disc 112 due to the concentric orientation of the influent passageways 154 and the effluent passageways 158 and the distribution channels 153.

Distribution of process fluids through the multiport rotary valve assembly 100 is conducted via internal porting of distribution channels 153 within the valve body 102 before flowing to the columns or vessels 104 in predetermined process sequences. Based on the material construction of the process disc 112, the multiport rotary valve assembly 100 is subject to fluid leakage if the spaces between the housing ring 110 and/or the upper and lower closure discs 107/114 and the process disc 112 are not properly sealed, especially during DLE applications. Furthermore, the distribution channels 153, influent passageways 154, and effluent passageways 158 may carry several different process fluids. The proximity of these various process fluids within the valve body 102 and process disc 112 presents potential leak paths, thus requiring sealing engagement.

To mitigate crossover leakage, prevent contamination or lithium recovery loss, and increase product purity, at least one ancillary tank or catch pot 108 is in fluid communication with the multiport rotary valve assembly 100. The multiport rotary valve assembly 100 includes internal porting of the leak detection channels intermediate of internal seals or seal assemblies. The detection channels are fluidly connected to the leak detection ports 106 in the valve body 102. The leak detection ports 106 are fluidly connected to the ancillary tank(s) or catch pot(s) 108. The catch pot(s) 108 at the intermediate ports 106 between the seals prevent the process fluids from intermixing and enable the process fluids to be collected and diverted to any desired tank, process step, or process zone of the multiport rotary valve assembly 100, the CCAD circuit 200, or both.

The collected process fluid leakage can be combined or mixed with the feed brine, strip solution, and/or product to form a combined solution before being diverted. Sensors, instruments, or other components 302 can be fluidly connected to the catch pot(s) 108 and/or the multiport rotary valve assembly 100 to detect, measure, analyze, and determine (via real-time or batch processing) which process fluid streams are being collected, and characterization of the collected crossover fluid or the combined solution can control where it is pumped in the multiport rotary valve assembly 100 or the CCAD circuit 200. For example, the sensors and instrumentation 302 can include a conductivity sensor, a nuclear magnetic resonance analyzer, an ion-selective electrodes, inductively coupled plasma optical emission spectroscopy (ICP-OES), inductively coupled plasma mass spectrometry (ICP-MS), ultraviolet-visible (UV-Vis) spectroscopy, Raman spectroscopy, a total dissolved solids analyzer, a density sensor, a flow sensor, an electrochemical sensor, a photochemical sensor, a spectrometry sensor, and/or other lithium detection sensor or instrumention fluidly connected to the catch pot(s) and configured to monitor and/or analyze the type of process fluid leakage collected and ensure that the collected process fluid leakage is recycled to the appropriate process zone(s) and/or fluid stream(s). The sensors and instrumentation 302 are configured to measure lithium ion concentration in aqueous solutions within the valve assembly 100 or the CCAD process circuit 200. The sensors and instrumentation 302 are operable for real-time, near-line, or offline analysis and may integrate with process control platforms, including SCADA or digital twin systems, for automated monitoring and optimization of lithium extraction and purification steps.

The catch pot(s) 108 operate at low pressure, and the high differential fluid pressures between the catch pot(s) 108 and the valve body 102 facilitate any leakage in the leak detection channels to flow from the ports 106 to the catch pot(s) 108. The catch pot(s) 108 can be any suitable ancillary reservoir, such as tanks, manifolds, porous bodies, and vacuum headers. The catch pot(s) can also be an integrated annular manifold, sump, reservoir pocket(s) machined into the valve body 102 rather than a separate tank. One or more pressure regulation sensors or instruments 304 can be fluidly connected to the catch pot(s) 108 and/or the multiport rotary valve assembly 100 (e.g., the process disc 112) to monitor and/or control the differential fluid pressures between the catch pot(s) 108 and the valve assembly 100. The pressure regulation sensor 304 can be a pressure reduction regulator or a back-pressure regulator, such as mechanical devices, valves, regulators, seals, manifolds, gauges, or other components that control and maintain the pressure between the catch pot(s) 108 and the process disc 112 and/or valve body 102 within a specified range.

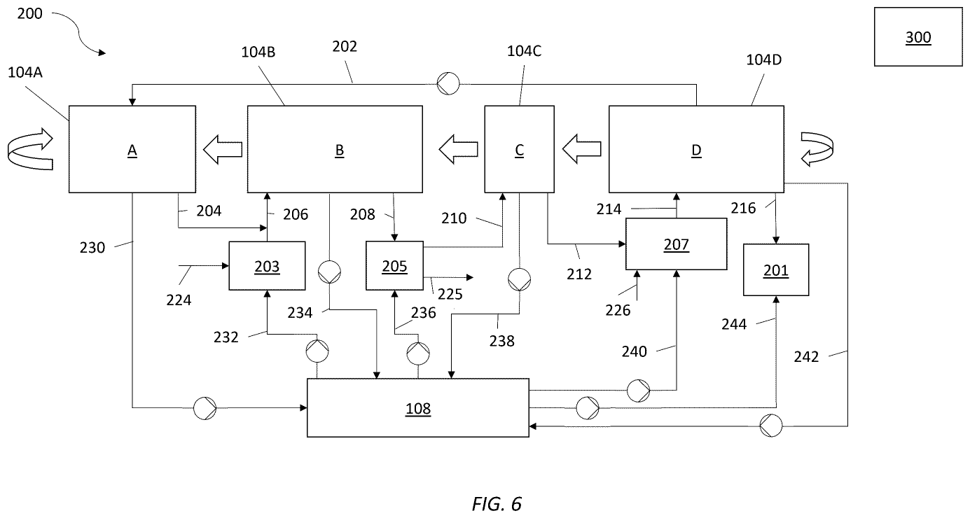

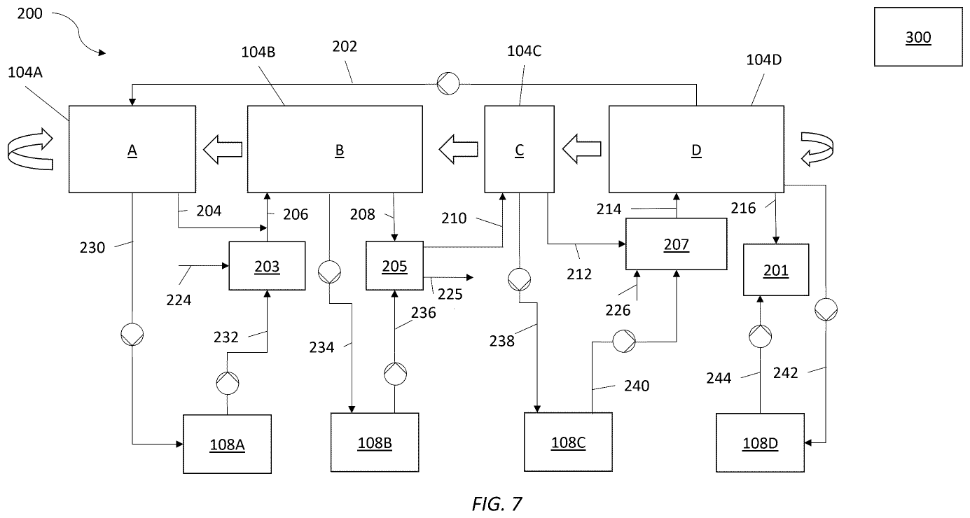

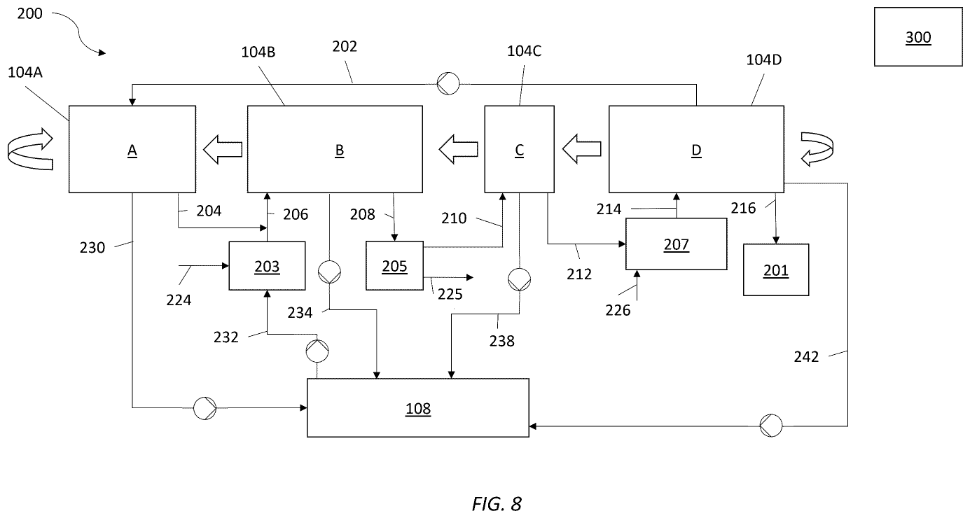

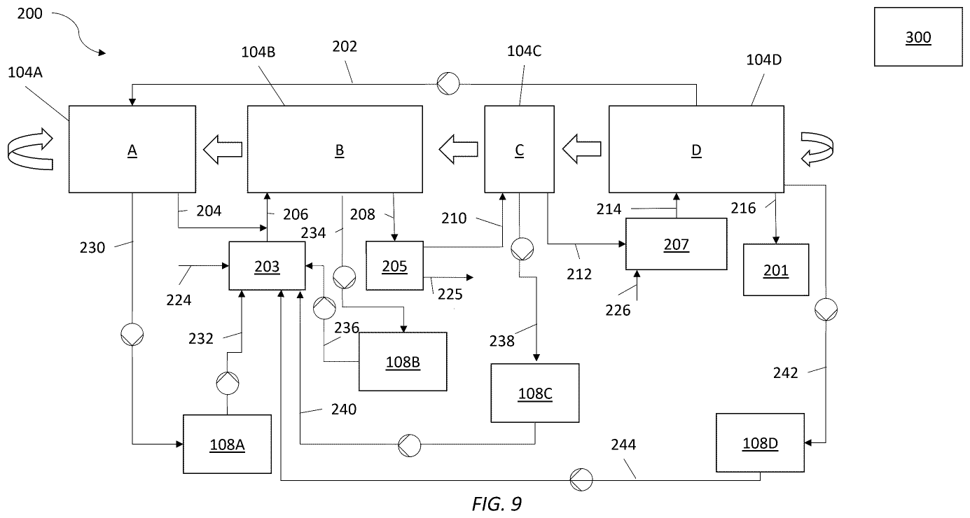

At a determined point, such as after reaching a predetermined level or volume, the collected process fluid leakage can be combined or mixed with the feed brine, strip solution, and/or product before being pumped from the catch pot(s) 108 to the selected tank, process unit, process stream, and/or process zone. For example, the collected process fluid leakage (alone or as the combined solution) can be pumped downstream to a tank, process stream, or process zone (e.g., FIGS. 6-7; the collected fluid leakage can be incorporated with the strip solution to form a combined strip solution and/or comprising with the product to form a combined product solution), upstream to a tank, process stream or unit, or process zone, (e.g., FIGS. 8-9; the collected fluid leakage can be incorporated with the feedstock solution to a feed tank to form a combined feedstock solution), inline to the multiport rotary valve assembly 100, and/or to any other selected tank, process stream or unit, process zone, or other inlet, outlet, point, or location in the flow path of the multiport rotary valve assembly 100 and/or the CCAD circuit 200.

Turning now to FIGS. 6 through 9, one or more of the multiport rotary valve assemblies 100 provide the CCAD circuit 200 with a plurality of process zones, each containing at least one adsorbent bed or column 104. As exemplified, the CCAD circuit 200 includes a brine displacement zone A, a brine loading zone B, a strip displacement zone C, and a product strip zone D; however, the CCAD circuit 200 is not so limited, and could include fewer or additional process zones (e.g., acid and/or caustic rinses) depending on the valve or circuit configuration (e.g., CCAD or CCIX), the brine or feedstock solution, or the product requirements.

The ancillary tank(s) or catch pot(s) 108 can be a consolidated catch pot fluidly connected to or in fluid communication with one or more selected tanks, process steps, or process zones. As shown in FIGS. 6 and 8, the consolidated catch pot 108 is fluidly connected to one or more of the leak detection ports 106 and in fluid communication with the brine displacement zone A, the brine loading zone B, the strip displacement zone C, and the product strip zone D. The ancillary tank(s) or catch pot(s) 108 can be a plurality of catch pots 108, each fluidly connected to or in fluid communication with one or more selected tanks, process steps, or process zones. As shown in FIGS. 7 and 9, a feed displacement catch pot 108A is fluidly connected to a leak detection port 106 and in fluid communication with the brine displacement zone A, a product loading catch pot 108B is fluidly connected to a leak detection port 106 and in fluid communication with the brine loading zone B, a strip displacement catch pot 108C is fluidly connected to a leak detection port 106 and in fluid communication with the strip displacement zone C, and a product strip catch pot 108D is fluidly connected to a leak detection port 106 and in fluid communication with the product strip zone D.

As illustrated in FIGS. 6 and 7, a portion of high lithium concentration product eluate 202 is pumped from the lithium product strip zone D to the displacement zone A, and an elution volume of feedstock solution 204 is displaced from the adsorbent or resin beds or columns 104A in the displacement zone A. The elution volume of high lithium concentration product eluate 202 drawn from the product strip zone D is at least enough to displace one adsorbent bed void fraction during an index time (the time interval between rotary valve assembly 100 indexes) from the adsorbent or resin beds or columns 104A in the displacement zone A. Any crossover fluid 230 leakage from the seals 176 into the leak detection channels in the brine displacement zone A is pumped from the ports 106 to the consolidated catch pot 108 (FIG. 6) or the feed displacement catch pot 108A (FIG. 7). The collected crossover fluid 232 can then be pumped from the consolidated catch pot 108 (FIG. 6) or the feed displacement catch pot 108A (FIG. 7) to a feed tank 203 fluidly connected to the brine displacement zone A and the brine loading zone B.

A feedstock brine or solution 224 is supplied to the feed tank 203. The combined feedstock solution 206 is pumped from the feed tank 203 to the adsorbent or resin beds or columns 104B in the brine loading zone B with a predetermined contact time sufficient to completely or almost completely load or exhaust the adsorbent or resin in the adsorbent or resin beds or columns 104B. The loading zone B is sized such that under the steady-state operation of the CCAD circuit 200, the complete lithium adsorption mass transfer zone is captured within the loading zone B. The lithium-depleted raffinate 208 exiting the loading zone B is sent to a depleted brine tank 205. The steady-state operation achieves maximum lithium loading without significant lithium leaving with the lithium-depleted raffinate 208 as tails. Any crossover product fluid 234 leakage from the seals 176 into the leak detection channels in the loading zone B is pumped from the ports 106 to the consolidated catch pot 108 (FIG. 6) or the product loading catch pot 108B (FIG. 7). The collected crossover product fluid 236 can then be pumped from the consolidated catch pot 108 (FIG. 6) or the product loading catch pot 108B (FIG. 7) to the depleted brine tank 205 fluidly connected to the brine loading zone B and the strip displacement zone C.

A portion of the combined lithium-depleted raffinate 225 is pumped from the depleted brine tank 205 to be returned to the brine aquifer, e.g., via reinjection, and another portion of the combined raffinate 210 is pumped from the depleted brine tank 205 to adsorbent or resin beds or columns 104C in the strip displacement zone C to displace latent eluate solution 212. The eluate solution 212 is carried forward as entrained fluid within the adsorbent or resin beds or columns 104C transitioning from the strip displacement zone C into adsorbent or resin beds or columns 104D in the lithium product strip zone D in the cyclic CCAD process circuit 200, back to the inlet of the product strip zone D. The elution volume of the raffinate 210 drawn from the depleted brine tank 205 to displace latent eluate solution 212 to an eluent tank 207 is at least enough to displace adsorbent or resin beds or columns 104C void fraction during each of the rotary valve assembly 100 index times in the strip displacement zone C. Any crossover displacement fluid 238 leakage from the seals 176 into the leak detection channels in the strip displacement zone C is pumped from the ports 106 to the consolidated catch pot 108 (FIG. 6) or the strip displacement catch pot 108C (FIG. 7). The collected crossover displacement fluid 240 can then be pumped from the consolidated catch pot 108 (FIG. 6) or the strip displacement catch pot 108C (FIG. 7) to the eluent tank 207 fluidly connected to the strip displacement zone C and the product strip zone D.

A lithium strip solution makeup-up 226 can be fluidly connected to the eluent tank 207. An eluant (lithium strip solution) 214 is pumped from the eluent tank 207 countercurrent to the process zone advance (fluid flow is illustrated as right to left, while the process zone movement is illustrated as left to right) into adsorbent or resin beds or columns 104D in the product strip zone D to produce an enhanced lithium product stream 216. The lithium strip solution 214 comprises a low-concentration lithium product eluant (as neutral salts, generally lithium chloride) in water, at a concentration ranging from about 0 mg/kg to about 1000 mg/kg of lithium, and at temperatures ranging from about 5° C. to about 100° C. Properly tuned, the CCAD circuit 200 recovers between about 90% and about 97% of the lithium from the feedstock solution and produces the enhanced lithium chloride product stream 216 having a concentration 10- to 50 -fold that of the feedstock solution with a greater than 99.9% rejection of hardness ions and most other solution components. The enhanced lithium product stream 216 is pumped from the adsorbent or resin beds or columns 104D in the product strip zone D to the lithium product tank 201. Any crossover product fluid 242 leakage from the seals 176 into the leak detection channels in the product strip zone D is pumped from the ports 106 to the consolidated catch pot 108 (FIG. 6) or the product strip catch pot 108D (FIG. 7). The collected crossover product fluid 244 can then be pumped from the consolidated catch pot 108 (FIG. 6) or the product strip catch pot 108D (FIG. 7) to the lithium product tank 201 fluidly connected to the product strip zone D.

The production of this high-purity lithium, without the need for extra rinse water, is an extremely cost-effective process of obtaining commercially valuable and substantially pure lithium chloride, suitable for conversion to battery-grade carbonate or hydroxide.

When crossover leakage is diverted and collected using the CCAD circuit 200 with one or more catch pots 108, the direct lithium extraction process enhances recovery and product quality, reduces process fluid crossover, and prevents contamination or loss of lithium during the recovery process. After leaving the CCAD circuit 200, the enhanced lithium chloride product stream 216 in FIGS. 6 and 7 can be passed to a lithium chloride concentration circuit and/or to a lithium carbonate and/or a lithium hydroxide conversion circuit. The lithium chloride conversion circuit removes selected remaining impurities, dewaters, and softens and further concentrates lithium in the lithium chloride product stream 221 before crystallization or electrolysis in the lithium carbonate and/or a lithium hydroxide conversion circuit.

The portion of high lithium concentration product eluate 202 that is recycled and displaces the feedstock solution 204 from the displacement zone A is enough fluid to completely displace salts from the adsorbent or resin beds or columns 104A before the adsorbent or resin beds or columns 104D enters the product strip zone D. This means that the displaced lithium-bearing feedstock solution 204 may be recycled into the tank 203 and introduced to the adsorbent or resin beds or columns 104B in the loading zone B with the feedstock solution 224. Depending on the tuning parameters of the CCAD circuit 200, the low lithium concentration in the recycled displacement feedstock solution 204 could significantly increase the effective concentration of lithium entering the loading zone B.

Rather than being pumped downstream as exemplified in FIGS. 6 and 7, the collected process fluid leakage (alone or as the combined solution) can be pumped upstream to a tank, process step, or process zone. In such an arrangement, the feed displacement catch pot 108A is fluidly connected to a leak detection port 106 and in fluid communication with the product strip zone D, the product loading catch pot 108B is fluidly connected to a leak detection port 106 and in fluid communication with the strip displacement zone C, the strip displacement catch pot 108C is fluidly connected to a leak detection port 106 and in fluid communication with the brine loading zone B, and a product strip catch pot 108D is fluidly connected to a leak detection port 106 and in fluid communication with the brine displacement zone A.

As illustrated in FIGS. 8 and 9, the collected process fluid leakage (alone or as the combined solution) can be pumped to a feed tank to form a combined feedstock solution. Similar to FIGS. 6 and 7, a portion of high lithium concentration product eluate 202 is pumped from the product strip zone D to the brine displacement zone A, and an elution volume of feedstock solution 204 is displaced from the adsorbent or resin beds or columns 104A in the brine displacement zone A. Any crossover fluid 230 leakage from the seals 176 into the leak detection channels in the brine displacement zone A is pumped from the ports 106 to the consolidated catch pot 108 (FIG. 8) or the feed displacement catch pot 108A (FIG. 9). The collected crossover fluid 232 can then be pumped from the consolidated catch pot 108 (FIG. 8) or the feed displacement catch pot 108A (FIG. 9) to a feed tank 203 in fluid communication with the brine displacement zone A and the brine loading zone B.

A feedstock brine or solution 224 is supplied to the feed tank 203. The combined feedstock solution 206 is pumped from the feed tank 203 to the adsorbent or beds or columns 104B in the brine loading zone B with a predetermined contact time sufficient to completely or almost completely load or exhaust the adsorbent or resin in the beds or columns 104B. The lithium-depleted raffinate 208 exiting the loading zone B is sent to a depleted brine tank 205. Any crossover product fluid 234 leakage from the seals 176 into the leak detection channels in the loading zone B is pumped from the ports 106 to the consolidated catch pot 108 (FIG. 8) or the product loading catch pot 108B (FIG. 9). The collected crossover product fluid 236 can then be pumped from the consolidated catch pot 108 (FIG. 8) or the product loading catch pot 108B (FIG. 9) to the feed tank 203 in fluid communication with to the brine loading zone B.

A portion of the combined lithium-depleted raffinate 225 is pumped from the depleted brine tank 205 to be returned to the brine aquifer, and another portion of the combined raffinate 210 is pumped from the depleted brine tank 205 to adsorbent or resin beds or columns 104C in the strip displacement zone C to displace latent eluate solution 212. The eluate solution 212 is carried forward as entrained fluid within the adsorbent or resin beds or columns 104C transitioning from the strip displacement zone C into adsorbent or resin beds or columns 104D in the lithium product strip zone D in the cyclic CCAD process circuit 200, back to the inlet of the product strip zone D. The elution volume of the raffinate 210 drawn from the depleted brine tank 205 to displace latent eluate solution 212 to an eluent tank 207 is at least enough to displace adsorbent or resin beds or columns 104C void fraction during each of the rotary valve assembly 100 index times in the strip displacement zone C. Any crossover displacement fluid 238 leakage from the seals 176 into the leak detection channels in the strip displacement zone C is pumped from the ports 106 to the consolidated catch pot 108 (FIG. 8) or the strip displacement catch pot 108C (FIG. 9). The collected crossover displacement fluid 238, 240 can then be pumped from the consolidated catch pot 108 (FIG. 8) or the strip displacement catch pot 108C (FIG. 9) to the feed tank 203 in fluid communication with to the brine loading zone B.

A lithium strip solution makeup-up 226 can be fluidly connected to the eluent tank 207. An eluant (lithium strip solution) 214 is pumped from the eluent tank 207 countercurrent to the process zone advance (fluid flow is illustrated as right to left, while the process zone movement is illustrated as left to right) into adsorbent or resin beds or columns 104D in the product strip zone D to produce an enhanced lithium product stream 216. The enhanced lithium product stream 216 is pumped from the adsorbent or resin beds or columns 104D in the product strip zone D to the lithium product tank 201. Any crossover product fluid 242 leakage from the seals 176 into the leak detection channels in the product strip zone D is pumped from the ports 106 to the consolidated catch pot 108 (FIG. 8) or the product strip catch pot 108D (FIG. 9). The collected crossover product fluid 242, 244 can then be pumped from the consolidated catch pot 108 (FIG. 8) or the product strip catch pot 108D (FIG. 9) to the feed tank 203 in fluid communication with to the brine loading zone B.

In another embodiment, the collected process fluid leakage could bypass the feed, strip, displacement, and other tanks and be pumped inline to the multiport rotary valve assembly(ies) 100. Notwithstanding the foregoing examples, the collected process fluid leakage could be pumped from the catch pot(s) 108 to any selected tank, process unit, process zone, process stream, and/or other inlet, outlet, channel, passageway, or location of the multiport rotary valve assembly 100 or the CCAD circuit 200.

In various embodiments, a system controller 300 is employed to control process conditions during concentration and extraction. The controller 300 will typically include one or more memory devices and one or more processors. A processor may include a CPU or computer, analog and/or digital input/output connections, stepper motor controller boards, etc.

The controller 300 may control all of the activities of the multiport rotary valve assembly 100, the CCAD circuit 200, or both. The system controller 300 executes system control software, including sets of instructions for controlling the timing, mixture of fluids, pressures, temperatures, flow rates, flow paths, compositions, and other parameters of a particular process. Other computer programs stored on memory devices associated with the controller 300 may be employed in some embodiments.

Typically, a user interface is associated with the controller 300. The user interface may include a display screen, graphical software displays of the apparatus and/or process conditions, and user input devices such as pointing devices, keyboards, touchscreens, microphones, and other similar devices.

System control logic may be configured in any suitable way. In general, logic can be designed or configured in both hardware and software. The instructions for controlling the drive circuitry may be hard-coded or provided as software. The instructions may be provided by “programming.” Such programming is understood to include logic of any form, including hard-coded logic in digital signal processors, application-specific integrated circuits, and other devices that have specific algorithms implemented as hardware. Programming is also understood to include software or firmware instructions that can be executed on a general-purpose processor. System control software may be coded in any suitable computer-readable programming language.

The computer program code for controlling the process fluid flow and other processes in a process sequence can be written in any conventional computer-readable programming language, such as assembly language, C, C++, Pascal, Fortran, or others. The processor executes compiled object code or script to perform the tasks identified in the program. Additionally, as indicated, the program code may be hard-coded.

The controller parameters relate to process conditions, such as process fluid composition, flow rates, temperature, pressure, pH, concentrations, and other relevant process parameters and conditions. These parameters are provided to the user and may be entered utilizing the user interface.

The system software may be designed or configured in many different ways. For example, various valve and circuit component subroutines or control objects may be written to control the operation of the valve and circuit components necessary to carry out the extraction processes in accordance with the disclosed embodiments. Examples of programs or sections of programs for this purpose include process disc and process fluid control code, catch pot and leakage fluid control code, pressure control code, and heater control code.

In some implementations, a controller 300 is part of a system, which may be part of the above-described examples. These systems may be integrated with electronics to control their operation before, during, and after the processing of a process or other fluid. The electronics may be referred to as the “controller,” which may control various components or subparts of the system or systems. The controller 300, depending on the processing requirements and/or the type of system, may be programmed to control any of the processes disclosed herein, including the delivery of processing fluids, temperature settings (e.g., heating and/or cooling), pressure settings, vacuum settings, power settings, flow path settings, fluid flow rate settings, positional and operation settings, and other operational components connected to or interfaced with a specific system.

Broadly speaking, the controller can be defined as electronics comprising various integrated circuits, logic, memory, and/or software that receive instructions, issue instructions, control operations, enable cleaning operations, and facilitate endpoint measurements, among other functions. The integrated circuits may include chips in the form of firmware that store program instructions, digital signal processors (DSPs), application-specific integrated circuits (ASICs), and/or one or more microprocessors or microcontrollers that execute program instructions (e.g., software). Program instructions are the instructions communicated to the controller in the form of various individual settings (or program files), which define operational parameters for carrying out a particular process.

The controller 300, in some implementations, may be part of or coupled to a computer that is integrated with, coupled to, or networked to the system, or a combination thereof. For example, the controller 300 may be in the “cloud” or all or a part of a host computer system, which can allow for remote access to the lithium or mineral processing. The computer may enable remote access to the system to monitor the current progress of concentration and extraction operations, examine a history of past concentration and extraction operations, examine trends or performance metrics from a plurality of concentration and extraction operations, change parameters of current processing, set processing steps to follow the current processing, or start a new process. Thus, as described above, the controller may be distributed, comprising one or more discrete controllers that are networked together and work towards a common purpose, such as the processes and controls described herein.

As used herein, the term “fluidly connected” means connected by a fluid transfer conduit or any other method that permits fluid transfer, with or without intervening elements, such as, without limitation, containers, filters, devices, pumps, valves, etc. A non-limiting example, two tanks or vessels may be “fluidly connected” if they are connected to each other through a pipe or tube, even if a pump, manifold, valve, or other device is placed inline between the vessels. Two elements are considered to be “fluidly connected” even though no pipe or tubing is making the connection if the first element leaks or otherwise drains, overflows, siphons, or transfers into the second element, though there may be no actual physical connection between the two elements in the form of a pipe or tube. As used herein, the term “in fluid communication with” means that a fluid-carrying or fluid-transporting member (e.g., vessel, tank, pump, pipe, tubing, disc, valve, channel, port, etc.) is coupled to another fluid-carrying or fluid-transporting member so as to permit the fluid to flow, leak, or otherwise migrate from one member to the other. In reference to a process or circuit, the term “downstream” means later in the direction of general process and/or fluid flow, and “upstream” means earlier in the direction of general process and/or flow.

The description of the invention is intended to be read in connection with the accompanying drawings, which are to be considered part of the entire written description of this invention. In the description, relative terms such as “front,” “rear,” “lower,” “upper,” “horizontal,” “vertical,” “above,” “below,” “up,” “down,” “top” and “bottom” as well as derivatives thereof (e.g., “horizontally,” “downwardly,” “upwardly” etc.) should be construed to refer to the orientation as then described or as shown in the drawings under discussion. These relative terms are for convenience of description and do not require that the machine be constructed or the method to be operated in a particular orientation. Terms such as “connected,” “coupled,” “connecting,” “attached,” “attaching,” “join,” and “joining” are used interchangeably and refer to one structure or surface being secured to another structure or surface or integrally fabricated in one piece.

Although an overview of the disclosed subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A multiport rotary valve assembly, comprising:
a valve body comprising a housing ring, an upper closure disc, a lower closure disc, and a process disc; the upper closure disc and the lower closure disc attached to opposing ends of the housing ring; the process disc seated within the housing ring; the process disc comprising distribution channels in a sealed arrangement with leak detection channels; the housing ring, the upper closure disc, and/or the lower closure disc comprising leak detection ports in fluid communication with the leak detection channels in the process disc; and
an ancillary tank or catch pot fluidly connected to the leak detection ports in the housing ring, the upper closure disc, and/or the lower closure disc; the catch pot configured to collect process fluid leakage from the distribution channels to the leak detection channels in the process disc of the valve body.

2. The assembly of claim 1, wherein the ancillary tank or catch pot comprises a consolidated catch pot fluidly connected to the leak detection ports in the housing ring, the upper closure disc, and/or the lower closure disc.

3. The assembly of claim 1, wherein the ancillary tank or catch pot comprises a plurality of ancillary tanks or catch pots, and each of the catch pots fluidly connected to one or more of the leak detection ports in the housing ring, the upper closure disc, and/or the lower closure disc.

4. The assembly of claim 1 further comprising a level sensor, a volume sensor, a pressure regulation sensor, and/or other sensor or instrumentation.

5. The assembly of claim 1, wherein the catch pot is configured to operate at low fluid pressure and the valve assembly is configured to operate at high fluid pressure.

6. The assembly of claim 5 further comprising a pressure regulation sensor or instrumentation fluidly connected to the catch pot and the valve assembly to monitor and/or control a differential pressure between the catch pot and the valve assembly.

7. The assembly of claim 6, wherein the pressure regulation sensor or instrumentation comprises a pressure reduction regulator or a back-pressure regulator.

8. The assembly of claim 1 further comprising a conductivity sensor, a nuclear magnetic resonance analyzer, an ion-selective electrode sensor, a total dissolved solids analyzer, a density sensor, a flow sensor, an electrochemical sensor, a photochemical sensor, a spectrometry sensor, and/or other lithium detection sensor or instrumention is fluidly connected to the catch pot and configured to monitor and/or analyze a type of process fluid leakage collected and ensure that the collected process fluid leakage is recycled to an appropriate process zone and/or fluid stream.

9. A continuous countercurrent adsorption and desorption circuit, the circuit comprising:
a multiport rotary valve assembly having a plurality of process zones, each of the process zones comprising an adsorbent or resin bed or column having an adsorbent or resin; and
an ancillary tank or catch pot in fluid communication with at least one of the process zones; the ancillary tank or catch pot configured to collect process fluid leakage from the multiport rotary valve assembly.

10. The circuit of claim 9, wherein the ancillary tank or catch pot comprises a plurality of ancillary tanks or catch pots, and each of the catch pots in fluid communication with one or more of the process zones.

11. The circuit of claim 10, wherein the ancillary tank or catch pot comprises a consolidated catch pot in fluid communication with the process zones.

12. The circuit of claim 11, wherein the consolidated catch pot is in fluid communication with a brine displacement zone, a brine loading zone, a strip displacement zone, and a product strip zone.

13. The circuit of claim 12 further comprising a brine displacement catch pot in fluid communication with the brine displacement zone, a brine loading catch pot in fluid communication with the brine loading zone, a strip displacement catch pot in fluid communication with the strip displacement zone, and a product strip catch pot in fluid communication with the product strip zone.

14. The circuit of claim 13 further comprising:
the brine displacement catch pot positioned upstream with respect to process fluid flow of and in fluid communication with the product loading catch pot;
the product loading catch pot positioned upstream with respect to process fluid flow of and in fluid communication with the strip displacement catch pot;
the strip displacement catch pot positioned upstream with respect to process fluid flow of and in fluid communication with the product strip catch pot; and
the product strip catch pot positioned upstream with respect to process fluid flow of and in fluid communication with the brine displacement catch pot.

15. The circuit of claim 9, wherein each of the process zones is in fluid communication with a leak detection channel of the multiport rotary valve assembly, wherein each of the leak detection channels is in fluid communication with a leak detection port of the multiport rotary valve assembly, and wherein each of the leak detection ports is fluidly connected to one or more of the ancillary tank or catch pot.

16. The circuit of claim 15, wherein the multiport rotary valve assembly further comprises a process disc having process fluid distribution channels in a sealed arrangement with the leak detection channels, and wherein the catch pot is configured to collect process fluid leakage from the distribution channels to the leak detection channels.

17. The circuit of claim 9 further comprising a level sensor, a volume sensor, a pressure regulation sensor, and/or other sensor or instrumentation fluidly coupled to the ancillary tank or catch pot.

18. The circuit of claim 9, wherein the catch pot is configured to operate at low fluid pressure and the valve assembly is configured to operate at high fluid pressure.

19. The circuit of claim 18, further comprising a pressure regulation sensor or instrumentation fluidly connected to the catch pot and valve assembly to monitor and/or control a differential pressure between the catch pot and the valve assembly.

20. The circuit of claim 19, wherein the pressure regulation sensor or instrumentation comprises a pressure reduction regulator or a back-pressure regulator.

21. The circuit of claim 9, further comprising a controller for controlling fluid flow of process fluid, the process fluid leakage, or both.

22. The circuit of claim 9 further comprising a conductivity sensor, a nuclear magnetic resonance analyzer, an ion-selective electrode sensor, a total dissolved solids analyzer, a density sensor, a flow sensor, an electrochemical sensor, a photochemical sensor, a spectrometry sensor, and/or other lithium detection sensor or instrumention is fluidly connected to the catch pot and configured to monitor and/or analyze a type of process fluid leakage collected and ensure that the collected process fluid leakage is recycled to an appropriate process zone and/or fluid stream.

23. A process, comprising the steps of:
concentrating a brine or feedstock solution using a continuous countercurrent adsorption and desorption circuit to form an enhanced product solution, wherein the continuous countercurrent adsorption and desorption circuit comprises a multiport rotary valve assembly having a plurality of process zones, each of the process zones comprising one or more adsorbent or resin beds or columns having an adsorbent or resin;
collecting process fluid leakage from the plurality of process zones using at least one ancillary tank or catch pot in fluid communication with the multiport rotary valve assembly; and
pumping the collected fluid leakage to a tank, process unit, process zone, process stream, and/or other inlet, outlet, point, or location in a flow path of the continuous countercurrent adsorption and desorption circuit, thereby mitigating crossover leakage, preventing contamination or product recovery loss, and increasing product purity.

24. The process of claim 23 further comprising the steps of:
incorporating the collected fluid leakage with:
the brine or feedstock solution to form a combined brine or feedstock
solution, a strip solution to form a combined strip solution, and/or the enhanced product solution to form a combined product solution; and
pumping one or more of the combined fluid solutions to the tank, process stream, process zone, and/or other inlet, outlet, point, or location in the flow path of the continuous countercurrent adsorption and desorption circuit.

25. The process of claim 23 further comprising the step of monitoring and/or controlling a level, volume, pressure, flow rate, flow path, temperature, or other process parameters of the ancillary tank or catch pot, the continuous countercurrent adsorption and desorption circuit, or both using a controller.

26. The process of claim 25 further comprising the step of regulating differential pressure between the ancillary tank or catch pot and the multiport rotary valve assembly.

27. The process of claim 23, wherein the step of collecting further comprises collecting the process fluid leakage from a leak detection port of the multiport rotary valve assembly, and wherein the leak detection port is in fluid communication with a leak detection channel and a distribution channel of the multiport rotary valve assembly.

28. The process of claim 23, wherein the step of collecting further comprises collecting the process fluid leakage from a brine displacement zone, a brine loading zone, a strip displacement zone, and a product strip zone using a consolidated ancillary tank or catch pot.

29. The process of claim 23, wherein the step of collecting further comprises collecting the process fluid leakage from a brine displacement zone using a brine displacement catch pot, from a brine loading zone using a brine loading catch pot, from a strip displacement zone using a strip displacement catch pot, and from a product strip zone using a product strip catch pot.

30. The process of claim 23, wherein the step of collecting further comprises determining a type of process fluid leakage collected.

31. The process of claim 30, wherein the process fluid leakage is pumped to the tank, process unit, process zone, process stream, and/or other inlet, outlet, point, or location in the flow path of the continuous countercurrent adsorption and desorption circuit based on the type of process fluid leakage collected.

32. The process of claim 23, wherein the step of pumping further comprises pumping the collected fluid leakage upstream and/or downstream to the tank, process unit, process zone, process stream, and/or other inlet, outlet, point, or location in the flow path of the continuous countercurrent adsorption and desorption circuit.

33. The process of claim 32, wherein the tank is a feed tank, a strip tank, a displacement tank, and/or a product tank.

34. The process of claim 23, wherein the step of pumping further comprises pumping the collected fluid leakage inline to the multiport rotary valve assembly to one or more predetermined channels or process zones.

35. The process of claim 23, wherein the process is a direct lithium extraction process.
